(19) United States
(12) Patent Application Publication
(10) Pub. No.: US 2016/0339421 A1
(43) Pub. Date: Nov. 24, 2016

(54) QUANTITATIVE PIPETTE

(71) Applicant: DONGTAI KEHUA MEDICAL INSTRUMENT CO., LTD., Jiangsu (CN)

(72) Inventor: Ronghua MA, Dongtai City, Jiangsu (CN)

(73) Assignee: Dongtai Kehua Medical Instrument Co., Ltd., Jiangsu (CN)

(21) Appl. No.: 14/763,131

(22) PCT Filed: Mar. 26, 2015
(86) PCT No.: PCT/CN2015/075083

§ 371 Date: Jul. 23, 2015

(30) Foreign Application Priority Data
Dec. 23, 2014 (CN) 201410820521.1

(51) Int. Cl. B01L 3/02

(52) U.S. Cl. CPC B01L 3/021; B01L 2400/0487; B01L 2200/0605; B01L 2300/0832; B01L 2300/0838; B01L 2300/123; B01L 2400/0481

(57) ABSTRACT

A quantitative pipette includes an air bag, an air-guiding tube, a liquid-storing capsule and a quantitative capillary. Said air bag, said air-guiding tube and said liquid-storing capsule are all made of transparent polymer material, and connected sequentially to be communicated through internal holes. Said quantitative capillary is made of transparent polymer material or glass material. The upper end of the quantitative capillary is inserted into the liquid-storing capsule and close to the air-guiding tube, and the lower end of the quantitative capillary projects out the liquid-storing capsule. Volume of the quantitative capillary is selected based on the volume of the liquid to be pipetted.

### TECHNICAL FIELD

The present invention relates to laboratory instruments, and particularly to an improved quantitative pipette.

### BACKGROUND ART

Quantitative pipetting is an operation, which is made in all the physical, chemical and biological laboratories all the time. For large-volume pipetting, glass or plastic pipettes are used domestically and at abroad. For small or micro volume pipetting, micro-volume pipettes are used in combination with disposable suction nozzles, domestically and at abroad. In recent years, some of domestic and foreign users also use an auto-suction quantitative micro-blood-sample collection tube produced by KEHUA medical devices Co., Ltd. Dongtai city, Jiangsu province in China. However, when the volume of pipetting required is relatively large, such as 50-1000 μl, it is not possible to achieve auto-suction of the sample by means of the capillary action of the auto-suction quantitative micro-blood-sample collection tube. Currently, pipettes which can be used to easily and accurately complete the pipetting of a relative large-volume liquid sample have not emerged domestically and at abroad.

### DISCLOSURE OF THE INVENTION

In view of the above shortcomings present in the prior art, the technical problem to be solved by the present invention is to provide a quantitative pipette, which can be used to easily and accurately complete pipetting of relatively large micro-volume liquid and has the characteristics of easy operation, low cost, being not in need of other auxiliary equipments and improving work efficiency, and especially, the possibility of cross-contamination in the biological experiments can be avoided.

In order to solve the above mentioned technical problems, the present invention solves the technical problem by the solution in which to the present invention provides a quantitative pipette, comprising: an air bag, an air-guiding tube, a liquid-storing capsule and a quantitative capillary. Said air bag, said air-guiding tube and said liquid-storing capsule are all made of transparent polymer material, and connected sequentially to be communicated through the internal holes. Said quantitative capillary is made of transparent polymer material or glass material. The upper end of the quantitative capillary is inserted into the liquid-storing capsule and close to the air-guiding tube, and the lower end of the quantitative capillary projects out the liquid-storing capsule. The volume of the quantitative capillary is selected based on the volume of the liquid needed to be pipetted.

Further, the volume of the quantitative capillary is determined by the product of the cross-sectional area of the inner cavity of the quantitative capillary and the length thereof. Preferably, the quantitative capillary is a hollow circular tube, and the cross-sectional area of the inner cavity of the quantitative capillary is determined by the inner diameter of the quantitative capillary.

Optionally, at least one of the ends of the quantitative capillary is conical. Preferably, both ends of the quantitative capillary are conical, and the middle portion of the quantitative capillary is cylindrical.

Optionally, the volume of the quantitative capillary is 30-1000 microliters.

Preferably, the upper portion of the liquid-storing capsule is ellipsoidal, and its lower portion is a hollow circular tube.

Preferably, both ends of the upper portion of the liquid-storing capsule are conical, the middle portion of the upper portion of the liquid-storing capsule is cylindrical, and the lower portion of the liquid-storing capsule is a hollow circular tube.

Further, the outer wall of the lower portion of the quantitative capillary and the inner wall of the lower portion of the liquid-storing capsule are partially abutted to each other and secured together by an adhesive.

Optionally, the air bag is flat or ellipsoidal, facilitating to be secured by squeezing with fingers during operation.

When using the above quantitative pipette provided by the present invention, lightly squeezing the air bag, the lower end of the quantitative capillary is immersed into the liquid to be sucked, and then the air bag is gently released, such that the liquid can be sucked into the quantitative capillary. When the quantitative capillary is filled fully, the excess liquid will overflow from the top of the quantitative capillary and flow into the liquid-storing capsule. When the liquid-sucking is stopped, the quantitative capillary is filled with the liquid sucked, its volume equaling to a preset volume. Some of the excess liquid is left in the liquid-storing capsule, at this time the liquid in the quantitative capillary can be fully dripped out by gently squeezing the air bag again, so that quantitative pipetting of micro-volume can be easily and accurately completed.

### BRIEF DESCRIPTION OF DRAWINGS

FIG. 1 is a structural schematic diagram of the quantitative pipette of an embodiment of the present invention (wherein its quantitative capillary is a hollow circular tube); and

FIG. 2 is a structural schematic diagram of the quantitative pipette of another embodiment of the present invention (wherein one end of its quantitative capillary is conical).

### DETAILED DESCRIPTION OF EMBODIMENTS

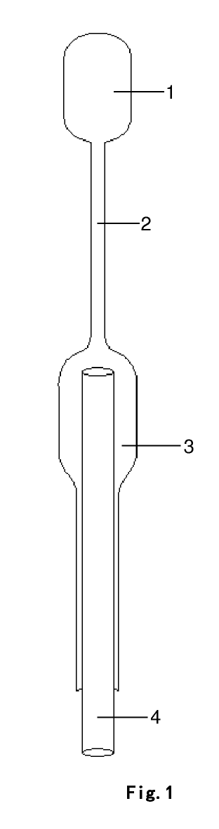

Referring to FIG. 1, the present invention provides a quantitative pipette, comprising: an air bag 1, an air-guiding tube 2, a liquid-storing capsule 3 and a quantitative capillary 4. Said air bag 1, air-guiding tube 2 and liquid-storing capsule 3 are all made of transparent polymer material, and connected sequentially to be communicated through the internal holes. Said quantitative capillary 4 is made of transparent polymer material or glass material. The upper end of said quantitative capillary 4 is inserted into said liquid-storing capsule 3 and close to said air-guiding tube 2, and the lower end of said quantitative capillary 4 projects out said liquid-storing capsule 3. The volume of said quantitative capillary 4 is selected based on the volume of the liquid needed to be pipetted.

It should be noted that the upper end of said quantitative capillary 4 is inserted into said liquid-storing capsule 3 and close to said air-guiding tube 2 and its lower end projects out said liquid-storing capsule 3. That is to say, the upper end of said quantitative capillary 4, located in the inside of said liquid-storing capsule 3, is close to said air-guiding tube 2 with a certain distance therebetween, so that the excess liquid sucked in the quantitative capillary 4 can overflow from the top of the quantitative capillary 4 and flow into the above mentioned liquid-storing capsule 3.

The volume of said quantitative capillary 4 is determined by the product of the cross-sectional area of the inner cavity of said quantitative capillary 4 and the length thereof.

Referring to FIG. 1, said quantitative capillary 4 is a hollow circuit tube (that is, the shape of said quantitative capillary 4 is cylindrical). The cross-sectional area of the inner cavity of said quantitative capillary 4 is determined by the inner diameter of said quantitative capillary 4.

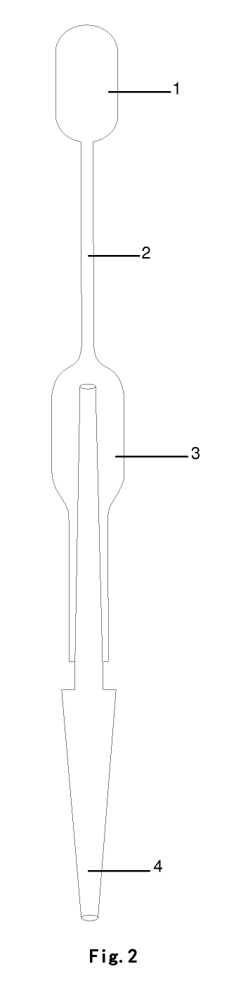

Referring to FIG. 2, at least one of the ends of said quantitative capillary 4 is conical. Optionally, one end of said quantitative capillary 4 is conical. Preferably, the lower end of said quantitative capillary 4 is conical (i.e., shown in FIG. 2). Optionally, both ends of said quantitative capillary 4 are conical, and the middle portion thereof is cylindrical.

It should be noted that the whole shape of said quantitative capillary 4, the shapes of one or two ends of the quantitative capillary and the shape of the middle portion thereof are not limited to cylindrical or conical, and can be other shapes existing in the prior art, for example, its two ends can be wedge-shaped etc, as long as it does not affect the suction and discharge of liquid by said quantitative capillary 4, the upper end of said quantitative capillary 4 does not contact with said air-guiding tube 2 and said liquid-storing capsule 3, and it does not affect the outer wall of the lower portion of said quantitative capillary 4 being partially bonded and adhesively secured to the inner wall of the lower portion of said liquid-storing capsule 3.

The volume of said quantitative capillary 4 is 30-1000 microliters. Therefore, based on the needs of users, the quantitative pipettes provided by the present invention can be embodied as pipettes with various capacities specification, such as 30 microliters, 40 microliters, 50 microliters, . . . , and 1000 microliters.

The upper portion of the liquid-storing capsule 3 is ellipsoidal, and its lower portion is a hollow circular tube.

Both ends of the upper portion of said liquid-storing capsule 3 are conical, the middle of the upper portion of said liquid-storing capsule 3 is cylindrical, and the lower portion of said liquid-storing capsule 3 is a hollow circular tube.

It should be noted that although the upper portion of said liquid-storing capsule 3 is ellipsoidal, or both ends of the upper portion of said liquid-storing capsule 3 are conical and the middle portion thereof is cylindrical, the shape of the upper portion of said liquid-storing capsule 3 is not limited to the above-mentioned two shapes, but the above-described two shapes are preferred. The shape of the upper part of said liquid-storing capsule 3 can be any shapes existing in the prior art, as long as it is possible to make the upper end of the quantitative capillary 4 located in the center inside said liquid-storing capsule 3, not in contact with the inner wall of said liquid-storing capsule 3, and not hinder the excess liquid from smoothly flowing into said liquid-storing capsule 3 when pipetting. For example, two ends of the upper portion of said liquid-storing capsule 3 are semi-spherical and the middle portion thereof is cylindrical, etc.

The outer wall of the lower portion of said quantitative capillary 4 and the inner wall of the lower portion of said liquid-storing capsule 3 are partially abutted and secured together by an adhesive, in order to prevent the excess liquid from flowing from the interior of said liquid-storing capsule 3 to pollute the environment.

Said air bag 1 is flat or ellipsoidal, facilitating to be secured by squeezing with figures during operation.

It should be noted that although said air bag 1 is flat or ellipsoidal, the shape of said air bag 1 is not limited to the flat form or spheroidal form, but the flat form or the spheroidal form is preferred. The shape of said air bag 1 can be other shapes existing in the prior art, as long as it is possible to facilitate the user to secure said air bag 1 by squeezing with fingers during operation. For example, said air bag 1 is spherical or conical in shape.

1. A quantitative pipette, comprising: an air bag, an air-guiding tube, a liquid-storing capsule and a quantitative capillary, wherein said air bag, said air-guiding tube and said liquid-storing capsule are all configured to be made of transparent polymer material and connected sequentially to be communicated through internal holes, said quantitative capillary is configured to be made of transparent polymer material or glass material, an upper end of said quantitative capillary is configured to be inserted into said liquid-storing capsule and close to said air-guiding tube, a lower end of said quantitative capillary is configured to project out of said liquid-storing capsule, wherein a volume of said quantitative capillary is selected based on volume of liquid to be pipetted.

2. The quantitative pipette according to claim 1, wherein the volume of said quantitative capillary is determined by product of a cross-sectional area and a length of an inner cavity of said quantitative capillary.

3. The quantitative pipette according to claim 2, wherein said quantitative capillary is a hollow circular tube, and the cross-sectional area of the inner cavity of said quantitative capillary is determined by an inner diameter of said quantitative capillary.

4. The quantitative pipette according to claim 1, wherein at least one end of said quantitative capillary is conical.

5. The quantitative pipette according to claim 1, wherein both ends of said quantitative capillary are conical, and a middle portion thereof is cylindrical.

6. The quantitative pipette according to claim 1, wherein the volume of said quantitative capillary is 30-1000 microliters.

7. The quantitative pipette according to claim 1, wherein an upper portion of said liquid-storing capsule is ellipsoidal, and a lower portion of said liquid-storing capsule is a hollow circular tube.

8. The quantitative pipette according to claim 1, wherein both ends of an upper portion of said liquid-storing capsule are conical, a middle of the upper portion of said liquid-storing capsule is cylindrical, and a lower portion of said liquid-storing capsule is a hollow circular tube.

9. The quantitative pipette according to claim 7, wherein an outer wall of the lower portion of said quantitative capillary and an inner wall of the lower portion of said liquid-storing capsule are configured to be partially abutted and secured together by an adhesive.

10. The quantitative pipette according to claim 1, wherein said air bag is flat or ellipsoidal, facilitating to be secured by squeezing with figures during operation.
